(19) United States
(12) Patent Application Publication
(10) Pub. No.: US 2014/0250069 A1
(43) Pub. Date: Sep. 4, 2014

(54) SYSTEMS AND METHODS FOR SELECTIVELY SYNCHRONIZING FILES

(71) Applicant: APPSENSE LIMITED, Warrington (GB)

(72) Inventors: Karthik LAKSHMINARAYANAN, Cupertino, CA (US); Joseph SAIB, Santa Clara, CA (US); Michael MILLS, Aurora, IL (US); Richard James SOMERFIELD, San Jose, CA (US)

(73) Assignee: APPSENSE LIMITED, Warrington (GB)

(21) Appl. No.: 13/782,014

(22) Filed: Mar. 1, 2013

(51) Int. Cl. G06F 17/30

(52) U.S. Cl. CPC G06F 17/30575
USPC 707/634

(57) ABSTRACT

Systems and methods are provided for selectively synchronizing files. Data is received from a remote storage device indicative of a set of files stored on the remote storage device. A first file from the set of files is downloaded, but not a second file from the set of files. Both (a) the first file and (b) data indicative of the second file are stored in a database. A list of files stored in the database is displayed, the list including the first file and the second file.

### TECHNICAL FIELD

Embodiments of the invention generally relate to selectively synchronizing files.

### BACKGROUND

With the proliferation of online data storage, it has become increasingly common for computing device users to access files and/or folders that are stored in a remote data store. The remote data store can be, for example, a data store that is connected to the computing device by a network, such as a local area network, a cellular network, the Internet, etc. To allow a user to access files when the computing device is not connected to the network, the computing device can be configured to locally store files and/or folders from the remote data store. For example, copies of the remote files can be stored in local storage devices that are part of, or directly connected to, the computing device, such as memory, hard drives, external USB drives, etc. The locally stored files and/or folders can be synchronized with their remote counterpart files and/or folders at the remote data store. The synchronization can ensure that, for example, changes made to a file, whether made locally at the computing device or remotely at the remote data store, are reflected at both the local storage as well as the remote data storage.

However, such remote data stores are often much larger than local storage devices. Therefore, the local storage may not have enough capacity to locally store the full set of files stored in the remote data storage. To deal with such local storage constraints, the user may choose to not synchronize some files and/or folders from the remote data store (e.g., so that the files are not copied locally). However, such unsynchronized files and/or folders will not appear in the local storage, and will not be accessible when the computing device is off-line. For example, if a user browses a directory with only some of the files copied locally, the user will only see those locally copied files. Therefore, the user will not know what unsynchronized files and/or folders exist at the remote storage device when browsing the local storage device(s).

### SUMMARY

In accordance with the disclosed subject matter, systems, methods, and non-transitory computer-readable media are provided for selectively synchronizing a computing device with remotely stored files. The user, or a system administrator, can configure which files and/or folders are downloaded to the computing device (and which are not). When the user browses the synchronized directory, the user can see both locally stored files and/or folders, as well as the remaining virtually apparent files/folders that are only stored on the remote server.

The disclosed subject matter includes a computerized method for selectively synchronizing files. The method includes receiving, by a computing device, data from a remote storage device indicative of a set of files stored on the remote storage device. The method includes downloading, by the computing device, a first file from the set of files, but not a second file from the set of files. The method includes storing, by the computing device, (a) the first file and (b) data indicative of the second file, in a database. The method includes displaying, by the computing device, a list of files stored in the database, the list including the first file and the second file.

The disclosed subject matter further includes a computing device for selectively synchronizing files. The server includes a database. The server also includes a processor in communication with the database, and configured to run a module stored in memory. The module stored in memory is configured to cause the processor to receive data from a remote storage device indicative of a set of files stored on the remote storage device. The module stored in memory is configured to cause the processor to download a first file from the set of files, but not a second file from the set of files. The module stored in memory is configured to cause the processor to store (a) the first file and (b) data indicative of the second file, in a database. The module stored in memory is configured to cause the processor to display a list of files stored in the database, the list including the first file and the second file.

The disclosed subject matter further includes a non-transitory computer readable medium. The non-transitory computer readable medium has executable instructions operable to cause an apparatus to receive data from a remote storage device indicative of a set of files stored on the remote storage device. The instructions are further operable to cause an apparatus to download a first file from the set of files, but not a second file from the set of files. The instructions are further operable to cause an apparatus to store (a) the first file and (b) data indicative of the second file, in a database. The instructions are further operable to cause an apparatus to display a list of files stored in the database, the list including the first file and the second file.

The techniques disclosed herein can allow a user to selectively synchronize files stored by a remote computer with a local computer. Regardless of whether a user synchronizes the local computer with a particular file (e.g., such that the local computer does or does not download a copy of the file), the file appears as if it is downloaded to the local computer (e.g., when viewed by a file system explorer program). By presenting both downloaded files and virtually apparent files that are only stored on the remote server, a user can still navigate through the entire set of files as if they are stored on the computing device, while preserving space on the local computer (e.g., since the virtually apparent files are not downloaded to local storage devices). Further, the computing device is configured such that if the user tries to access the file, the computing device can automatically retrieve a copy of the file from the remote device.

These and other capabilities of the disclosed subject matter will be more fully understood after a review of the following figures, detailed description, and claims. It is to be understood that the phraseology and terminology employed herein are for the purpose of description and should not be regarded as limiting.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is an exemplary diagram of a system in accordance with some embodiments;

FIG. 2 is an exemplary diagram of files selectively synchronized from a remote database to a local database, in accordance with some embodiments;

FIG. 3 is an exemplary diagram of a computerized method for selectively synchronizing files, in accordance with some embodiments; and

FIG. 4 is an exemplary diagram of a computerized method for automatically downloading an unsynchronized file, in accordance with some embodiments.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid unnecessary complication of the disclosed subject matter. In addition, it will be understood that the embodiments provided below are exemplary, and that it is contemplated that there are other systems and methods that are within the scope of the disclosed subject matter.

The disclosed techniques enable a user to selectively synchronize files with a remote data store. Both the synchronized and unsynchronized (e.g., downloaded and not downloaded) files are displayed to the user when the user browses the local file system, such that to the user it appears as if all of the files are downloaded to the computer. The user can access both the synchronized and unsynchronized files (e.g., the synchronization program is configured to automatically download an unsynchronized file if the user attempts to access the unsynchronized file). Further, the user can access and manipulate the synchronized files even when the computing device is off-line. U.S. patent application Ser. No. 13/763,595, entitled “System and Method for Locally Storing Files From a System Server,” filed on Feb. 8, 2013, describes exemplary file synchronization systems and methods, and is hereby incorporated by reference herein in its entirety. U.S. patent application Ser. No. 13/418,090, entitled “Systems and Methods for Synchronizing Files in a Networked Communication System,” filed on Mar. 12, 2012, also describes exemplary synchronization techniques, and is hereby incorporated by reference herein in its entirety.

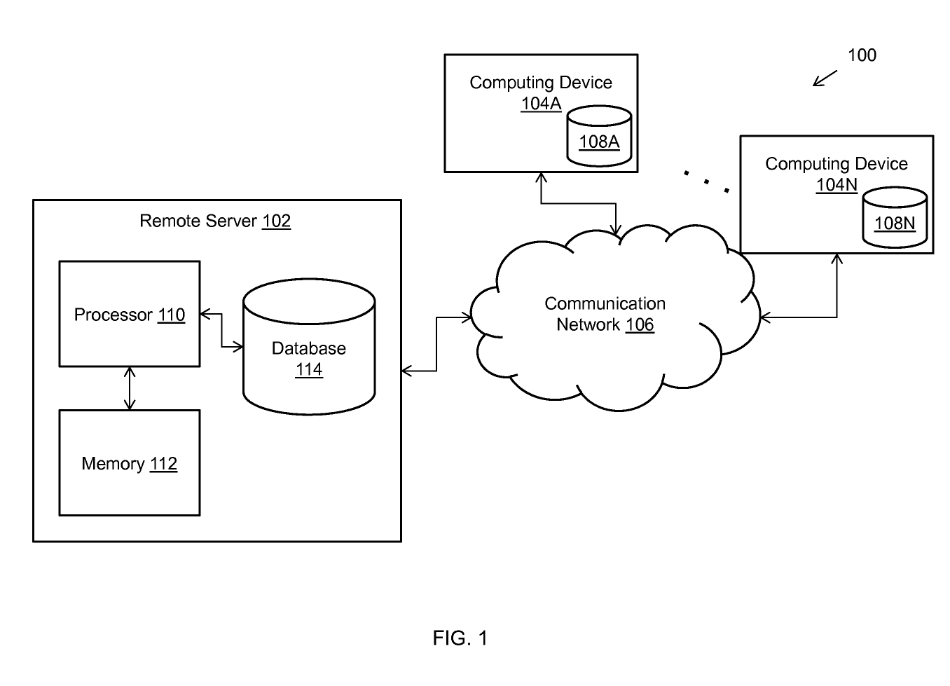

FIG. 1 is an exemplary diagram of a system 100 in accordance with some embodiments. System 100 includes remote server 102. The remote server 102 can, for example, remotely store data (e.g., files, folders, etc.). Remote server 102 is in communication with computing device 104A through 104N (collectively, computing device 104) through communication network 106. Each computing device 104 includes an associated local database 108. Server 102 includes processor 110, memory 112, and database 114. Processor 110 is in communication with memory 112 and database 114. The computing device 104 can access data stored by the remote server 102 (e.g., in database 114), and selectively synchronize its local storage 108 with the data stored in the database 114.

The communication network 106 can include a network or combination of networks that can accommodate public or private data communication. For example, the communication network 106 can include a local area network (LAN), a cellular network, a telephone network, a computer network, a packet switching network, a line switching network, a wide area network (WAN), any number of networks that can be referred to as an Intranet, and/or the Internet. Such networks may be implemented with any number of hardware and software components, transmission media and network protocols. FIG. 1 shows the network 106 as a single network; however, the network 106 can include multiple interconnected networks listed above.

Processor 110 can be configured to implement the functionality described herein using computer executable instructions stored in a temporary and/or permanent non-transitory memory such as memory 112. Memory 112 can be flash memory, a magnetic disk drive, an optical drive, a programmable read-only memory (PROM), a read-only memory (ROM), or any other memory or combination of memories. The processor 110 can be a general purpose processor and/or can also be implemented using an application specific integrated circuit (ASIC), programmable logic array (PLA), field programmable gate array (FPGA), and/or any other integrated circuit. Similarly, databases 108 and 114 may also be flash memory, a magnetic disk drive, an optical drive, a programmable read-only memory (PROM), a read-only memory (ROM), or any other memory or combination of memories. The remote server 102 can execute an operating system that can be any operating system, including a typical operating system such as Windows, Windows XP, Windows 7, Windows 8, Windows Mobile, Windows Phone, Windows RT, Mac OS X, Linux, VXWorks, Android, Blackberry OS, iOS, Symbian, or other OSs.

The components of system 100 can include interfaces (not shown) that can allow the components to communicate with each other and/or other components, such as other devices on one or more networks, server devices on the same or different networks, or user devices either directly or via intermediate networks. The interfaces can be implemented in hardware to send and receive signals from a variety of mediums, such as optical, copper, and wireless, and in a number of different protocols some of which may be non-transient.

The software in remote server 102 and/or remote computing devices 104 can be divided into a series of tasks that perform specific functions. These tasks can communicate with each other as desired to share control and data information throughout the computing device (e.g., via defined Application Programmer Interfaces (“APIs”). A task can be a software process that performs a specific function related to system control or session processing. In some embodiments, three types of tasks can operate within the computing devices: critical tasks, controller tasks, and manager tasks. The critical tasks can control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem (as described below), and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem can be a software element that either performs a specific task or is a culmination of multiple other tasks. A single subsystem can include critical tasks, controller tasks, and manager tasks. Some of the subsystems that run on the computing device can include a system initiation task subsystem, a high availability task subsystem, a shared configuration task subsystem, and a resource management subsystem.

The system initiation task subsystem can be responsible for starting a set of initial tasks at system startup and providing individual tasks as needed. The high availability task subsystem can work in conjunction with the recovery control task subsystem to maintain the operational state of the computing device by monitoring the various software and hardware components of the computing device. Recovery control task subsystem can be responsible for executing a recovery action for failures that occur in the computing device and receives recovery actions from the high availability task subsystem. Processing tasks can be distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will preferably not be affected by that problem.

A shared configuration task subsystem can provide the computing device with an ability to set, retrieve, and receive notification of server configuration parameter changes and is responsible for storing configuration data for the applications running within the computing device. A resource management subsystem can be responsible for assigning resources (e.g., processor and memory capabilities) to tasks and for monitoring the task's use of the resources.

In some embodiments, the computing device can reside in a data center and form a node in a cloud computing infrastructure. The computing device can also provide services on demand such as Kerberos authentication, HTTP session establishment and other web services, and other services. A module hosting a client can be capable of migrating from one server to another server seamlessly, without causing program faults or system breakdown. A computing device in the cloud can be managed using a management system.

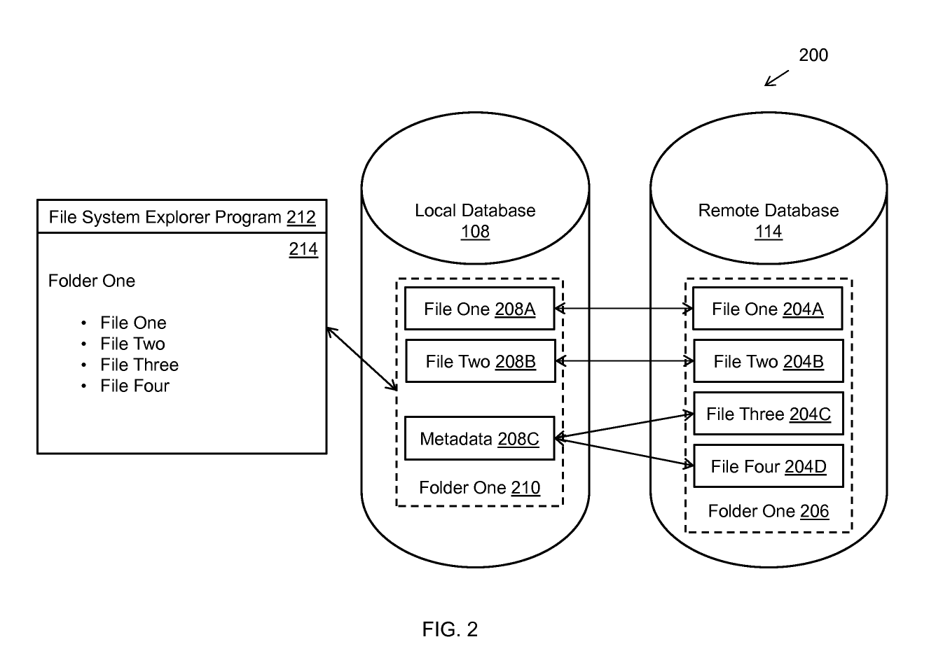

FIG. 2 is an exemplary diagram of files selectively synchronized from remote database 114 to local database 108, in accordance with some embodiments. As shown in FIG. 1, the remote database 114 is a database in remote server 102, and the local database 108 is a local database for a computing device 104 (e.g., database 108A for computing device 104A). The remote database 108 stores folder one 206, which includes file one 204A, file two 204B, file three 204C, and file four 204D. Local database 202 stores (or locally downloads) file one 208A and file two 208B, and stores metadata 208C for file three 204C and file four 204D (e.g., data sufficient to identify files three 204C and 204D without downloading the two files). As shown in FIG. 2, file one 208A in the local database 108 is synchronized with file one 204A in the remote database 114 (e.g., such that changes made locally to file one 208A are also made to file one 204A, or vice versus). Similarly, file two 208B in the local database 108 is synchronized with file two 204B from the remote database 114.

FIG. 2 is for illustrative purposes only, and is not intended to be limiting. One of skill in the art can appreciate that the databases 108 and 114 may store any number of files and/or folders, and may include any number of databases. Further, the computing device 104 can be configured to download and synchronize various subsets of files and/or folders from the remote database 114 to the local database 108. For example, the computing device 104 can be configured to download and synchronize various sets of files from different folders, and/or to not download and synchronize any files for a particular folder or sets of folders.

The computing device 104 can execute a synchronization program to synchronize files between the remote database 114 and the local database 108. A user can use the synchronization program to configure which files are synchronized between the databases, e.g., such that a copy of a file on the remote database 114 is copied locally to the local database 108, and changes made to the file and/or its local counterpart are carried through in both files.

The file system explorer program 212 is a program that can be executed by computing device 104. When the computing device 104 executes the file system explorer program 212 to view the files stored in folder one 210 in local database 108, the file system explorer program 212 executes the synchronization program to generate the display 214, which displays an entry for each of the files one, two, three and four for folder one 210. Files one and two correspond to file one 208A and file two 208B stored in the local database 108. Files three and four are identified based on the metadata 208C, but are only stored on remote database 114 as file three 204C and file four 204D. The metadata can be, for example, a file with all the same attributes (e.g., including file type, file size, etc.), but the actual bytes in the content of the file are not downloaded from the remote server (e.g., if/until the user attempts to open the file). For example, while the file size attribute shown in in the operating system file listing window is the actual file size as stored on the remote server (e.g., as shown using “File Manager” in Windows, “Finder” in OSX), the content of the file is not stored in the file.

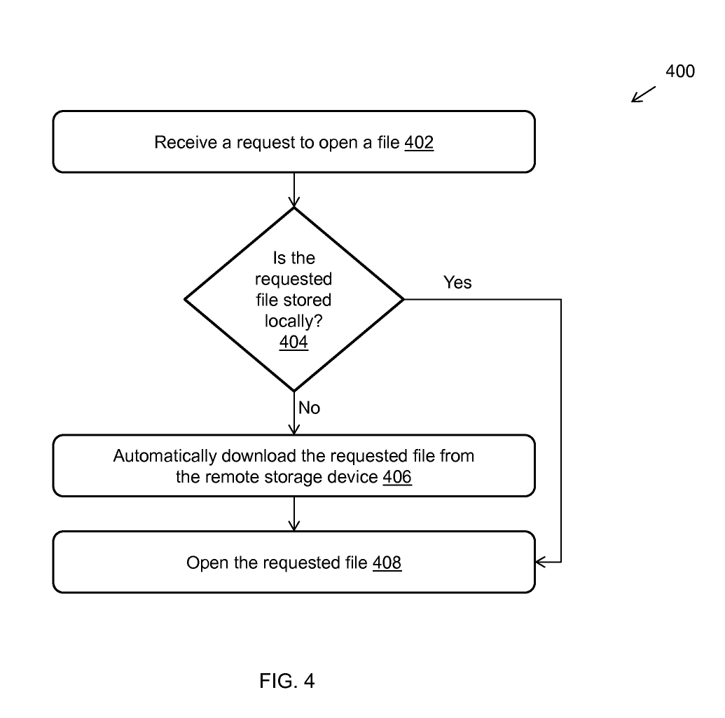

In some embodiments, the synchronization program is executed by the operating system kernel. For example, for Windows-based computing devices, the synchronization program can be implemented as a kernel driver, which is essentially a driver for the operating system kernel that can be invoked when Windows displays its files (e.g., via Windows Explorer) such that the kernel driver code can automatically execute the methods described herein (e.g., to copy files, open files, retrieve files, etc.). As another example, for Mac-based computing devices, since Macs usually don't support kernel drivers, the Fuse library can be used, which is a user-space kernel extension. Similar to the kernel driver for Windows, the Mac kernel extension automatically invokes the synchronization program when the Mac displays its files. Such kernel drivers allow the file synchronization techniques discussed herein to be executed transparently to a user, such that a user is unaware of the synchronization process. For example, a user is unaware if the kernel drivers request to open a file that is not synchronized (e.g., locally downloaded), as is described further with respect to FIG. 4.

As an illustrative example, a user can download the synchronization program to the computing device 104 (e.g., from a web server, not shown, via network 106). In some examples, the user can download a specific version of the synchronization program. For example, the user can download a version for a particular company from an application store for the company, which is pre-configured with which remote servers 102 to use. In another example, the user can download a generic version and configure the remote server 102 (or servers) to use for synchronization. The user can execute an installer for the synchronization program, which installs the synchronization application, hooks the application into the kernel, and completes any additional set-up steps (e.g., re-booting the computing device's operating system, etc.). Once installed, the user can view files using standard utilities provided by the operating system (e.g., a DOS prompt, a file manager program such as Windows Explorer, opening a file with Microsoft Word, etc.), and custom utilities. Regardless of the utility used to view the files, since the synchronization program is executing with the operating system kernel, it is automatically executed to control the drives managed by the synchronization program using the techniques described herein. For example, as shown in FIG. 2, when the operating system file system explorer program 212 is executed by the computing device 104, it automatically executes the custom synchronization program code and shows files one through four within folder one, even though file three 204C and file four 204D are not stored in local database 108. As another example, the custom synchronization program is configured such that if a user tries to access a file shown in the file system explorer program 212, the program requests the file from the operating system, the operating system identifies that folder one is being managed by the synchronization program, and the file is requested from the synchronization program (e.g., such that if the file is stored locally, it is opened, otherwise the synchronization program downloads the file from the remote database). This is described in further detail with respect to FIG. 4.

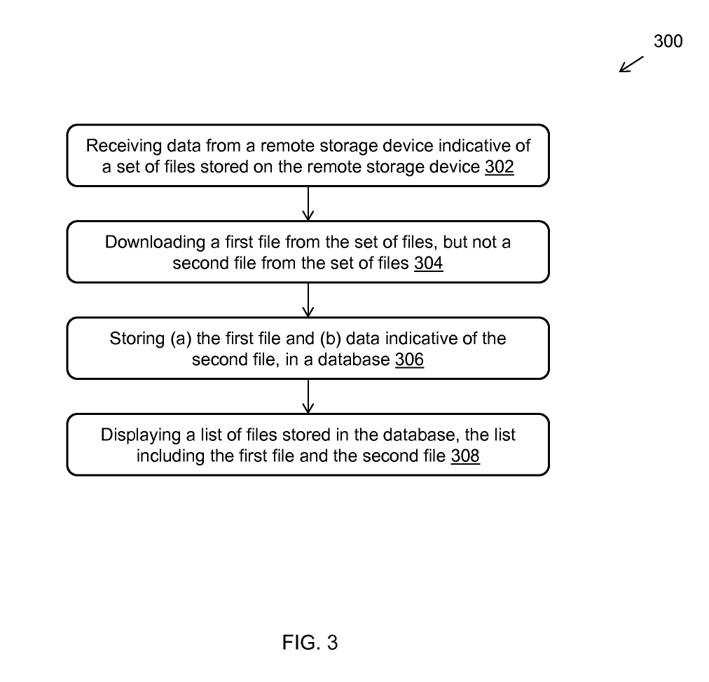

FIG. 3 is an exemplary diagram of a computerized method 300 for selectively synchronizing files, in accordance with some embodiments. Referring to FIGS. 1 and 2, at step 302 the computing device 104 executes the synchronization program and receives data from remote database 114 that is indicative of a set of files stored on the remote storage device. For example, the data is indicative of remote database 114 storing at least folder one 206, which includes file one 204A, file two 204B, file three 204C and file four 204D. In some embodiments, the user of the computing device 104 may need to log onto or otherwise authenticate itself with the remote server 102 prior to being given access to data stored on the remote server 102.

At step 304, the computing device 104 downloads a first file from the set of files, but not a second file from the set of files stored by the remote server 102. For example, the computing device 104 downloads file one 204A and file two 204B from the remote server 102. However, computing device 104 does not download file three 204C or file four 204D from the remote server 102.

Referring further to step 304, the computing device 104 can be configured to download any set of files and/or folders stored by the remote server 102. For example, the computing device 104 can execute the synchronization program to customize which files are synchronized between the computing device 104 and the remote server 102. Such a program can generate configuration data that the computing device 104 uses to determine whether to download (and/or synchronize) files and/or folders from the remoter server 102.

For example, the computing device 104 can receive configuration data that configures which files to download from the remote storage device. The computing device 104 can receive the configuration data from the network 106, from a program operating on the computing device 104, from a remote computer, and/or the like. The configuration data can specify which files to download from the remote server 104, and which files not to download from the remote server 102. Referring to FIG. 2, for example, the configuration data can include configuration data instructing the computing device 104 (e.g., which is read and/or otherwise used by a synchronization program being executed on the computing device 104) to download file one 204A and file two 204B from the remote database 114, but to not download file three 204C or file four 204D. In some embodiments, even though the computing device 104 does not download file three 204C or file four 204D from the remote database 114, the computing device 104 still downloads metadata for files 204C and file four 204D that is sufficient to identify the files (e.g., by a file explorer program, as described further herein).

Referring further to step 304, the synchronization program can be used to manage a directory on the computing device 104. The directory appears to the user like a local drive, not a network drive. Therefore, if the computing device 104 is off-line, the directory can still be viewed and/or accessed by a user. For example, a user can still add and/or change files in the synchronized directory when the computing device 104 is off-line, and the new and/or edited data can be synchronized with the remote serve 102 when the computing device 104 is back online with the network 106 (or a different network).

The synchronization program can, for example, allow a company to manage data stored on the company's network 106 (e.g., an intranet) so that a user can use network files even when the computing device 104 is not connected to the network 106. For example, work-issued computing devices 104 can be configured to map a particular drive (e.g., the Z or U drive) to a network drive stored on the remote server 102. The user (or system administrator) can install the synchronization application and configure which files are downloaded to the computing device so that a user can access those files even when the computing device 104 is not connected to the internet. For example, the user can authenticate itself with the synchronization application (e.g., via login), and then receive a list of files stored in the remote database 114 so that the user can configure which files are synchronized (e.g., locally stored) with the remote database 114. The user can then access such synchronized files even if the computing device is not connected to the network 106.

The user can also add new files to the synchronization application that are not yet stored by the remote server 102. As described above, a directory being managed by the synchronization application can be configured to appear to the user as a typical directory. Therefore, for example, a user can add new files to the synchronization application by saving the file in the synchronized directory (e.g., using a “save” option from a program), dragging and dropping the new file into the directory, and/or other file manipulation routines. The synchronized directory can be configured such that when it receives a new and/or changed file, the computing device 104 uploads the new file (or changed file) to the remote server 102.

A user can change the configuration data for a synchronized drive. For example, the computing device 104 can receive updated configuration data for the synchronizing program that is used by the synchronization program to update the local storage. The configuration information can be generated by the synchronization program, or a different program. If, for example, the updated configuration information includes configuration data to download a file from the remote database 114 that is not yet downloaded to the local database 108, the computing device 104 can download the new file (e.g., file three 204C and/or file four 204D).

As another example, if the updated configuration information includes data indicative of a file that is to no longer be synchronized with the remote database 114, the computing device 104 can be configured to delete the locally stored copy in database 108. For example, if the updated configuration data indicates the computing device 104 is to no longer synchronize file one 208A (which is synchronized with file one 204A stored on remote database 114), then the computing device 104 can delete file one 208A from the local database 108. The computing device 104 can delete file one 208A to conserve space in local database 108 (e.g., such as where the remote database 114 includes more files than the storage space in local database 108 can download). In some embodiments, the computing device 104 does not delete the corresponding file (e.g., file one 204A) from the remote database 204A. As is described further with FIG. 4, even if the local database 108 does not include a local copy of a file on the remote database 114, the computing device 104 can download a copy of the file if necessary (e.g., if the computing device 104 needs to open the file, such as in response to a request from a user). The computing device 104 can download the file, for example, if the computing device 104 never downloaded the file, and/or if the computing device 104 deleted a local copy of the file after receiving updated configuration information.

As an illustrative example, an IT administrator can initially configure which shares are downloaded to the computing device 104, and which shares are virtually apparent on the computing device 104 (e.g., via metadata). For example, the IT administrator can configure the synchronized drive such that a first drive (or folder) is synchronized, while a second and third drive are not synchronized (e.g., the user's home drive is downloaded, but two common company drives are not downloaded). Therefore, the user can still browse the synchronized drive and see all three sub-drives, but actions on the synchronized drive will occur quicker than actions on the virtually apparent drives (e.g., since the files are already downloaded for the first folder). Similarly, for example, the user can only access files on the virtually apparent drives when the computing device 104 is connected to the remote server 102. Therefore, if the user wishes to access one of the virtually apparent drives faster (or while off-line), the user can configure the shared drive to also download that virtually apparent drive. As an example, the user can launch a configuration program (e.g., which may be part of the synchronization program) to select which folders are synchronized via a user interface. As another example, the user can right click on the file or folder and configure whether to synchronize it or not.

At step 306, the computing device 104 stores (a) the first file and (b) data indicative of the second file, in the database 108. For example, the computing device 104 stores locally stores file one 204A and file two 204B as file one 208A and file two 208B in local database 108. The computing device 104 stores metadata 208C, which is indicative of the third file 204C and the fourth file 204D. The metadata can be indicative of both files and/or folders stored by the remote server 102.

At step 308, the computing device 104 displays a list of files stored in the local database 108. For example, the metadata that the computing device 104 stores in place of downloaded files and/or folders is sufficient for the computing device 104 to identify the files and/or folders (e.g., including the relationship in a file structure, such as the path to the particular files). The computing device 104 can use the downloaded files in combination with the metadata to display (e.g., via a display on computing device 104) a full list of files stored in the remote database 114 as if all of the files were downloaded to the local database 108. For example, referring to FIG. 2, the list displayed in area 214 lists all of the files one through four as if they are all stored in the local database 108, when in fact only file one 208A and file two 208B are stored in local database 108.

As described above, the remote database 114 can include a complex set of files and folders (e.g., where the folders are nested within other folders, and each folder includes different files). The data received from the remote server 102 can include information about all the files and folders (e.g., which can be requested by a synchronizing program being executed on the computing device 104, and/or a separate program used to configure the synchronizing program). The synchronizing program is robust enough such that a user can specific which files, folders, drives, etc. within the complex file structure to download (and/or synchronize), and which to not download (e.g., by executing method 300 for each folder in the file system).

FIG. 4 is an exemplary diagram of a computerized method for automatically downloading an unsynchronized file, in accordance with some embodiments. Referring again to FIGS. 1 and 2, at step 402 the computing device 104 receives a request to open a file. For example, the synchronization program being executed by the computing device 104 can intercept a call from the operating system to open a file within a drive managed by the synchronization program.

At step 404, the synchronization program determines whether the requested file is stored locally in local database 108. If the file is not stored in local database 108, then method 400 proceeds to step 406. If the file is stored in local database 108, then method 400 proceeds to step 408. At step 406, the computing device 104, executing the synchronization program, automatically downloads a copy of the file from the remote database 114 and locally stores the copy in local database 108.

For example, if the computing device 104 receives a request to open file three 204C (e.g., which a file system explorer program displays as if the file is stored in the local database 108 via the metadata 208C, as described above), then the computing device 104 can download file three 204C and locally store a copy in the local database 108, without the user knowing the file was not already locally stored. Then the computing device 104 can open the file (e.g., so that a user can view and/or edit the file). As another example, if the computing device 104 receives a request to open file two 208B, since file two 208B is already stored in local storage, the computing device 104 can open file two 208B (e.g., without downloading any information from the remote database 114).

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A computerized method for selectively synchronizing files, the method comprising:
receiving, by a computing device, data from a remote storage device indicative of a set of files stored on the remote storage device;
downloading, by the computing device, a first file from the set of files, but not a second file from the set of files;
storing, by the computing device, (a) the first file and (b) data indicative of the second file, in a database; and
displaying, by the computing device, a list of files stored in the database, the list including the first file and the second file.

2. The method of claim 1, further comprising:
receiving configuration data for configuring which files from the set of files to download from the remote storage device, the configuration data comprising:
first configuration data to download the first file; and
second configuration data to not download the second file; and
downloading the first file but not the second file based on the configuration data.

3. The method of claim 2, further comprising:
receiving updated configuration data comprising third configuration data to download the second file; and
downloading the second file based on the configuration data.

4. The method of claim 1, further comprising:
receiving a request to download the second file; and
downloading the second file and storing the second file in the database.

5. The method of claim 1, further comprising:
receiving a request to open the second file;
automatically downloading the second file from the remote storage device; and
opening the second file.

6. The method of claim 1, wherein the data from the remote storage device is indicative of the set of files being in a first folder stored on the remote storage device, and the data is further indicative of a second set of files in a second folder stored on the remote storage device, the method further comprising:
downloading a third file from the second set of files, but not a fourth file from the second set of files; and
storing (a) the third file and (b) data indicative of the fourth file, in the database.

7. The method of claim 6, further comprising displaying the first folder and the second folder.

8. The method of claim 7, further comprising:
receiving a request to display the second set of files in the second folder; and
displaying the third file and the fourth file.

9. The method of claim 8, further comprising:
receiving a request to open the fourth file;
automatically downloading the fourth file from the remote storage device; and
opening the fourth file.

10. A computing device for selectively synchronizing files, the server comprising:
a database; and
a processor in communication with the database, and configured to run a module stored in memory that is configured to cause the processor to:
receive data from a remote storage device indicative of a set of files stored on the remote storage device;
download a first file from the set of files, but not a second file from the set of files;
store (a) the first file and (b) data indicative of the second file, in a database; and
display a list of files stored in the database, the list including the first file and the second file.

11. A non-transitory computer readable medium having executable instructions operable to cause an apparatus to:
receive data from a remote storage device indicative of a set of files stored on the remote storage device;
download a first file from the set of files, but not a second file from the set of files;
store (a) the first file and (b) data indicative of the second file, in a database; and
display a list of files stored in the database, the list including the first file and the second file.
